(19) United States
(12) Patent Application Publication
(10) Pub. No.: US 2009/0037827 A1
(43) Pub. Date: Feb. 5, 2009

(54) Video conferencing system and method

(76) Inventor: Christopher Lee Bennetts, Hsin Tien City (TW)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/888,389

(22) Filed: Jul. 31, 2007

(51) Int. Cl. G06F 3/00

(52) U.S. Cl. 715/753

(57) ABSTRACT

A video conferencing system, comprising an electronic device having a conferencing module interface executable to display video content in a main media window and at least one media sub-window, the video content in the main media window selectively interchangeable with the video content in the at least one media sub-window to facilitate viewing thereof

### BACKGROUND

Video conferencing systems enable participants at different locations to conduct conferences. Such video conferencing systems utilize personal computers having web cameras and microphones to capture and transmit audio/video content to conference participants. However, such video conferencing systems are difficult to navigate and use (e.g., difficult to view participants and/or other media content), thereby increasing the complexity of the video conferences.

### BRIEF DESCRIPTION OF THE DRAWINGS

FIG. 1 is a diagram illustrating an embodiment of a video conferencing system in which an embodiment of a conferencing module interface is employed to advantage;

FIG. 2 is a diagram illustrating an embodiment of a conferencing module interface of an electronic device of the video conferencing system of FIG. 1;

FIG. 3 is a diagram illustrating a pop-up menu system of the conferencing module interface of FIG. 2;

FIG. 4 is a diagram illustrating a simulcast pop-up menu of the conferencing module interface of FIG. 2; and

FIG. 5 is a diagram illustrating a view of another conferencing module interface of FIG. 2.

### DETAILED DESCRIPTION OF THE DRAWINGS

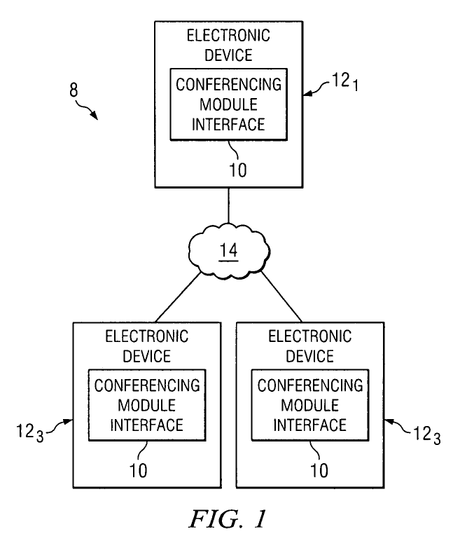

Various embodiments and the advantages thereof are best understood by referring to FIGS. 1-5, like numerals being used for like and corresponding parts of the various drawings.

FIG. 1 is a diagram illustrating an embodiment of a video conferencing system 8 in which an embodiment of a conferencing module interface 10 is employed to advantage. In the embodiment illustrated in FIG. 1, video conferencing system 8 comprises a plurality of electronic devices 12₁, 12₂, and 12₃ communicatively coupled via a communications network 14 to facilitate a video conferencing between users of electronic devices 12₁, 12₂ and 12₃. Electronic devices 12₁, 12₂ and/or 12₃ may comprise any type of electronic device such as, but not limited to, a notebook or laptop computer, a desktop computer, a karaoke device, or any other type of portable or non-portable electronic device. In the embodiment illustrated in FIG. 1, three electronic devices 12₁, 12₂ and 12₃ are illustrated; however, it should be understood that a greater or fewer number of electronic devices 12₁, 12₂, and/or 12₃ may be used in connection with system 8. In the embodiment illustrated in FIG. 1, each electronic device 12₁, 12₂ and 12₃ comprises an instance of conferencing module interface 10 to facilitate a group video conferencing among users of electronic devices 12₁, 12₂ and/or 12₃. According to some embodiments, communications network 14 comprises a local area network; however, it should be understood that communications network 14 may be any type of wired and/or wireless communications network (e.g., the Internet, a cellular network, etc.) that enables video conferencing between electronic devices 12₁, 12₂ and 12₃.

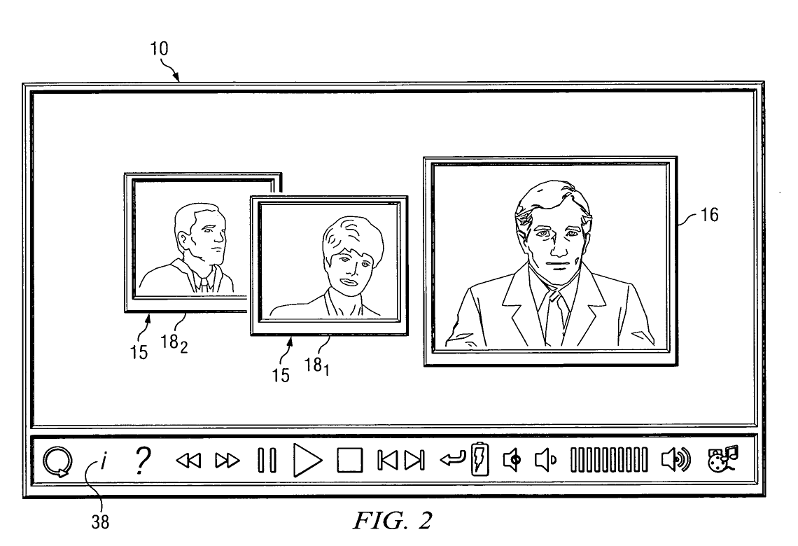

FIG. 2 is a diagram illustrating an embodiment of conferencing module interface 10 of an electronic device 12 of FIG. 1 (e.g., electronic device 12 representative of all or some of devices 12₁, 12₂ and/or 12₃) configured to display a plurality of media windows 15. In operation, conferencing module interface 10 comprises displays media windows 15 to display video content of users of electronic devices 12₁, 12₂ and/or 12₃ during a video conference. For example, in the embodiment illustrated in FIG. 2, media windows 15 comprise a main media window 16 and media sub-windows 18₁ and 18₂ to enable a video conference/conversation between participants. In the embodiment illustrated in FIG. 2, main media window 16 and media sub-windows 18₁ and 18₂ display live video feeds of respective video conference participants (e.g., users of electronic devices 12₁, 12₂ and 12₃) to enable real-time viewing of each participant on system 8. For example, if media windows 15 illustrated in FIG. 2 correspond to electronic device 12₁, main media window 16 displays live video feeds of the user of electronic device 12₁, and media sub-windows 18₁ and 18₂ display live video feeds of users of electronic devices 12₂ and 12₃, respectively. In the embodiment illustrated in FIG. 2, main media window 16 is larger than media sub-windows 18₁ and 18₂; however, it should be understood that main media window 16 and media sub-windows 18₁, and 18₂ may be otherwise configured and/or re-sized (e.g., equal in size and/or main media window 16 may be sized smaller than media sub-windows 18₁). Furthermore, conferencing module interface 10 is configured to display a greater or fewer number of media sub-windows 18. For example, in the event a particular video conference has four participants, conferencing module interface 10 causes the display of main media window 16 and three media sub-windows 18 to accommodate the four video conference participants (e.g., the users of electronic devices 12₁, 12₂, 12₃ and 12₄). Thus, in the event users of four electronic devices 12 are participating the video conference, main media window 16 and three media sub-windows 18 are configured to display live video feeds of each respective participant in the video conference.

According to some embodiments, media sub-windows 18₁ and 18₂ are cascadingly positioned. For example, in FIG. 2, media sub-window 18₂ is positioned and displayed parallel to and behind media sub-window 18₁. It should be understood that media sub-windows 18 may be otherwise arranged (e.g., adjacently positioned and disposed as appearing to be in the same plane).

In operation, the video content displayed in media sub-windows 18₁ and/or 18₂ are selectively interchangeable with video content displayed in main media window 16 to facilitate viewing of video content from media sub-window 18₁ or 18₂ in main media window 16 and viewing of video content from main media window 16 in media sub-window 18₁ or 18₂. For example, in the embodiment illustrated in FIG. 2, content displayed in media sub-window 18₁ is displayable within main media window 16 and content displayed in main media window 16 is displayable within media sub-window 18₁ in response to scrolling via arrow keys on a keyboard of electronic device 12, via directional arrows on a remote control or otherwise. According to some embodiments, video content within media sub-windows 18₁ and 18₂ may be interchanged with video content in main media window 16 in response to using a mouse (e.g., clicking on a media sub-window 18₁ or 18₂ and dragging into main media window 16) a stylus (e.g., selecting a media sub-window 18₁ or 18₂ via a stylus and dragging into main media window 16) or any other similar functioning input device.

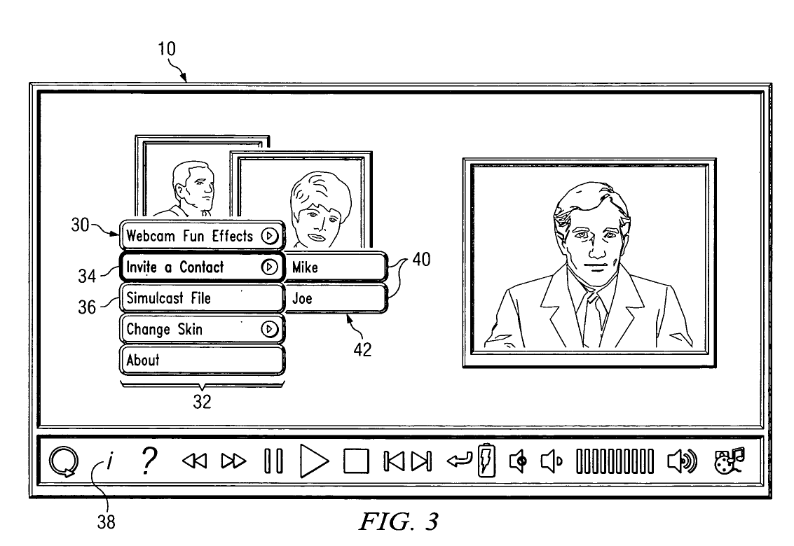

FIG. 3 is a diagram illustrating a pop-up menu system 30 of conferencing module interface 10 in FIG. 2. In the embodiment illustrated in FIG. 3, menu-system 30 is hidden from view until invoked by a user of electronic device 12. In the embodiment illustrated in FIG. 3, pop-up menu system 30 comprises a plurality of menu options 32 to facilitate the input of commands to electronic device 12 (FIG. 1). For example, in the embodiment illustrated in FIG. 2, menu options 32 comprises an “invite a contact” command 34 for inviting and/or removing video conference participants and a “simulcast file” command 36 to enable conferencing module interface 10 to simulcast a music file, picture file, a video file and/or any other type of file during a video conference. It should be understood that a greater or fewer number of menu options 32 may be utilized on menu system 30 to facilitate providing input commands for the operation and/or control of video conferencing system 8.

According to some embodiments, menu system 30 is invoked in response to a user pressing and/or otherwise activating a menu display button 38; however, it should be understood that other methods of invoking menu system 30 are available (e.g., via remote control, by pressing a stylus on interface 10, by right-clicking a mouse on conferencing module interface 10, etc.). Once menu system 30 has been invoked, menu system 30 is navigatable to enable a user to select the “invite a contact’ command 34 to facilitate display of a listing of available and/or registered participants 40. In operation, a user of electronic device 12 selects the “invite a contact” command 34 via a mouse, remote control, stylus, keyboard or otherwise. Once selected, for example, by holding and/or positioning a cursor over the “invite a contact’ command 34 of menu system 30, conferencing module interface 10 causes a sub-menu 42 to display a list of all available video conference participants 40 to enable the user of electronic device 12 to select the desired participant(s) for the video conference via a mouse, remote control, stylus, keyboard or otherwise. In operation, as participant(s) 40 are selected, conferencing module interface 10 causes media sub-window(s) 18 to be displayed corresponding to each participant 40 to facilitate the display of video content associated with the selected participant(s). According to some embodiments, menu system 30 is removed or hidden from view from conferencing module interface 10 in response to selecting menu display button 38. It should be understood that conferencing module interface 10 may be otherwise configured such that menu system 30 is automatically removed from view after a predetermined period of time of no activity (e.g., no use of pop-up menu system 30).

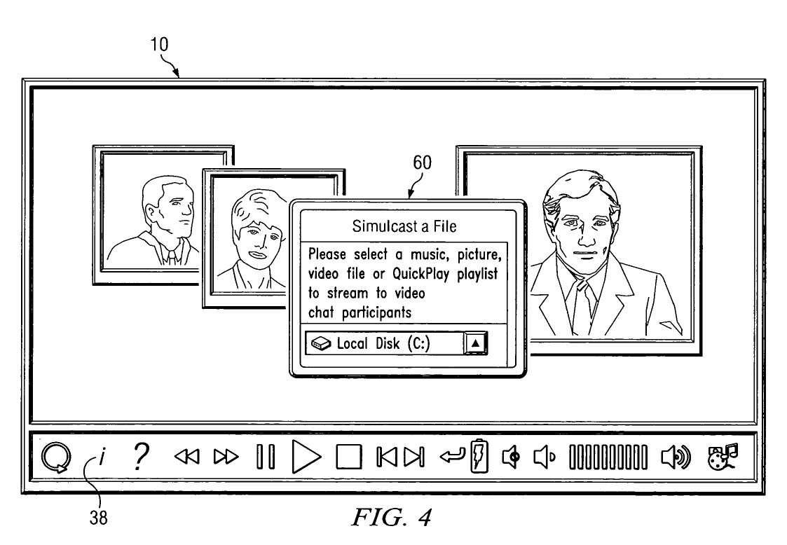

FIG. 4 is a diagram illustrating a simulcast pop-up menu 60 of conferencing module interface 10 of FIG. 2. In the embodiment illustrated in FIG. 4, in response the selection of “simulcast file” command 36 (FIG. 3), interface 10 displays simulcast menu 60. Simulcast menu 60 enables a user of electronic device 12 (e.g., electronic device 12₁) to select a desired file (e.g., a picture file, a video file or any other type of file) to be simulcast via conferencing system 8 for display on recipient electronic devices 12 (e.g., electronic devices 12₂ and/or 12₃). For example, in the embodiment illustrated in FIG. 4, if it is desired to simulcast a prerecorded video message to users of electronic devices 12₂ and/or 12₃, interface 10 displays pop-up menu 60 on electronic device 12, to enable the user of electronic device 12₁ to locate and select the desired simulcast file. Once selected, electronic device 12₁ transmits the video message to electronic devices 12₂ and 12₃ for viewing by respective users of electronic devices 12₂ and/or 12₃.

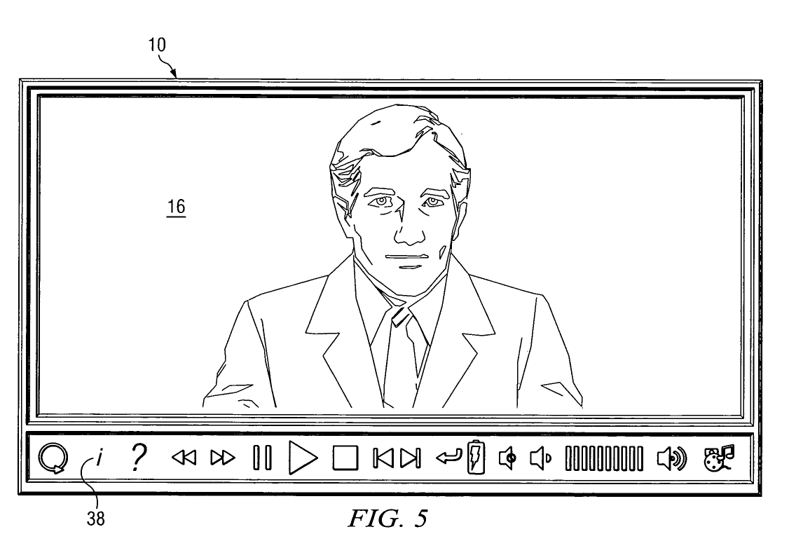

FIG. 5 is a diagram illustrating another view of interface 10 of FIG. 2 in an expanded/enlarged mode. For example, in the embodiment illustrated in FIGS. 2 and 5, conferencing module interface 10 causes main media window 12 to be enlarged (FIG. 5) in response to a user clicking on or otherwise selecting main window 12 (FIG. 2) via a mouse, remote control, stylus, keyboard or otherwise. In operation, conferencing module interface 10 causes main media window 12 to return to its original size in response to clicking and/or otherwise selecting main media window 12 (FIG. 5) another time.

In the embodiment illustrated in FIGS. 1-5, conferencing module interface 10 is configured as a full screen interface; however, it should be understood that conferencing module interface 10 may cover only a portion of a display screen.

Thus, embodiments of conferencing module interface 10 enables a video conference participant to navigate to view media content during video-conferencing. Furthermore, embodiments may be implemented in software and can be adapted to run on different platforms and operating systems. In particular, functions implemented by conferencing module interface 10, for example, may be provided as an ordered listing of executable instructions that can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this document, a computer-readable medium can be any means that can contain, store, communicate, propagate or transport the program for use by or in connection with the instruction execution system, apparatus or device. The computer-readable medium can be, for example but is not limited to, an electronic, magnetic, optical, electro-magnetic, infrared, or semiconductor system, apparatus, device or propagation medium.

What is claimed is:

1. A video conferencing system, comprising:
an electronic device having a conferencing module interface executable to display video content in a main media window and at least one media sub-window, the video content in the main media window selectively interchangeable with the video content in the at least one media sub-window to facilitate viewing thereof.

2. The system of claim 1, wherein the main media window display video content associated with a user of the electronic device.

3. The system of claim 1, wherein the main media window displays video content associated with a user of the electronic device and wherein the media sub-window displays video content associated with a user of another electronic device.

4. The system of claim 1, wherein video content of the main-media window and the at least one media sub-window are interchanged by scrolling through the media sub-windows.

5. The system of claim 1, wherein the interface is executable to cause display of media sub-window in response to receiving a selection of an invite-a-contact command.

6. The system of claim 1, wherein the interface is configured to cascadingly display a plurality of media sub-windows.

7. The system of claim 1, wherein the video content of the at least one sub-media window is interchanged with the video content of the main media window in response to selecting and dragging the video content of the at least one sub-media window to the main media window.

8. A video conferencing method, comprising:
displaying video content on an electronic device in a main media window and at least one media sub-window, the video content in the main media window selectively interchangeable with the video content in the at least one sub-media window to facilitate viewing thereof.

9. The method of claim 8, further comprising displaying video content associated with a user of the electronic device.

10. The method of claim 8, further comprising displaying video content associated with a user of the electronic device and wherein the media sub-window displays video content associated with a user of another electronic device.

11. The method of claim 8, further comprising interchanging the video content within the main media window with the video media content of the at least one sub-media window via scrolling between the sub-media windows.

12. The method of claim 8, further comprising causing display of media sub-window in response to receiving a selection of an invite-a-contact command.

13. The method of claim 8, further comprising cascadingly positioning a plurality of media sub-windows.

14. The method of claim 8, further comprising interchanging the video content of the at least one media sub-window with the video content of the main media window in response to selecting and dragging the video content of the media sub-window to the main media window.

15. A video conferencing system, comprising:
an electronic means having a conferencing module interface means executable to display video content in a main media window means and at least one media sub-window means, the video content in the main media window means selectively interchangeable with the video content in the at least one media sub-window means to facilitate viewing thereof.

16. The system of claim 15, wherein the main media window means displays video content associated with a user of the electronic means.

17. The system of claim 15, wherein the main media window means displays video content associated with a user of the electronic means and wherein the media sub-window means displays video content associated with a user of another electronic means.
